(19) United States
(12) Patent Application Publication
(10) Pub. No.: US 2025/0360465 A1
(43) Pub. Date: Nov. 27, 2025

(54) Nanostructured high-performance thin film composite reverse osmosis membranes and methods of manufacture

(71) Applicant: Greenvi Corp., Edmonton (CA)

(72) Inventors: Ahmad Rahimpour, Edmonton (CA); Sadegh Aghapour Aktij, Edmonton (CA); Mohtada Sadrzadeh, Edmonton (CA)

(21) Appl. No.: 18/675,069

(22) Filed: May 27, 2024

(51) Int. Cl. B01D 69/12; B01D 61/02; B01D 67/00; B01D 69/02; B01D 69/10; B01D 69/14; B01D 71/56; B01D 71/68

(52) U.S. Cl. CPC B01D 69/1251; B01D 67/00113; B01D 67/0013; B01D 69/02; B01D 69/1071; B01D 69/1216; B01D 69/14111; B01D 71/56; B01D 71/68; B01D 61/025; B01D 2323/02; B01D 2323/08; B01D 2323/12; B01D 2323/216; B01D 2323/2189; B01D 2323/219; B01D 2325/04; B01D 2325/20; B01D 2325/36; B01D 2325/48

(57) ABSTRACT

This disclosure relates to the fabrication of high-performance thin film composite (TFC) reverse osmosis (RO) membranes comprising a thin polyamide rejection layer (thickness of 100-200 nanometer), a porous substrate including polysulfone (PSf) layer (thickness of 40-50 micron) cast on polyester nonwoven fabric (thickness of ˜100 micron). Hydrophilic and antibacterial TFC polyamide RO membranes were developed by incorporating green Lignin and nanostructured silver-based metal organic frameworks (MOFs) into the selective layer. The polyamide layer of TFC RO membranes was fabricated on the porous PSf substrate by interfacial polymerization between aqueous monomer solutions containing MPD, and adequate additives in water and organic monomer solutions containing TMC in the mixture of hexane and co-solvents. The optimized produced RO membranes were provided water flux of 95-100 LMH and sodium chloride (NaCl) salt rejection of 98.5-99.0% during filtration of 2000 ppm NaCl solution at 225 psi pressure, and water flux of 55-60 LMH and sodium chloride (NaCl) salt rejection of 98.6-98.9% during filtration of 35000 ppm NaCl solution at 800 psi pressure. This disclosure also relates to developing a roll-to-roll PSf membrane as a substrate for making TFC RO membranes for water desalination

### TECHNICAL FIELD

This disclosure relates to nanostructured high-performance thin film composite reverse osmosis membranes and methods of manufacture, including fabricating hydrophilic and antibacterial thin film composite (TFC) reverse osmosis (RO) membranes with high permeability and salt rejection membranes for water desalination.

### BACKGROUND

The following paragraphs are not an admission that anything discussed in them is prior art or part of the knowledge of persons skilled in the art.

Fresh water availability for different uses in human civilization is worsening because of population increase, urbanization, and industrialization. Therefore, to meet the increasing demand for clean water, reverse osmosis (RO) and nanofiltration (NF) processes have been recognized as promising technologies to treat wastewater and desalinate salty water because of the technological cleanliness involved in the process and the less energy-intensive demand. These membrane technologies are now accepted worldwide technologies to meet the considerable shortage of clean water. The performance of membranes in RO process is the key to the successful operation of the plant in which the membranes with high flux and salt rejection are favorable for the efficient operation of the RO system. RO membranes developed in the market mainly include thin-film composite (TFC) membranes consisting of fully aromatic polyamide selective layer formed on top of a porous polymeric substrate having a woven/non-woven layer via interfacial polymerization. The microporous support layer merely serves to support the membrane during fabrication, handling, and operation at high pressures, while the ultrathin selective layer separates water molecules from salt molecules. The primary function of the woven/non-woven layer is to act as a support to increase the mechanical strength of the TFC membranes. The properties and chemistry of the thin polyamide selective layer, which enable the membrane to deliver high flux and salt rejection, are adjusted to produce high-quality potable water from wastewater and seawater. Producing high-performance TFC membranes with high water permeability, high salt retention, and/or low fouling will reduce the water treatment plant's chemical consumption, membrane area, operational cost, and energy. Membranes for reverse osmosis have still been under progression to tackle the challenges like low selectivity and high fouling resistance. It remains challenging to provide high water flux in combination with other desirable membrane properties, such as salt rejection and resistance to fouling.

The applicant has developed new types of thin film composite (TFC) and thin film nanocomposite (TFN) membranes with hydrophilic Lignin and a silver-based metal organic framework to enhance the permeability, fouling resistance, and antibacterial properties without scarifying salt rejection.

Lignin is generated in a large quantity as a by-product of pulp and paper industries. The inherent properties of lignin, such as hydrophilicity, polyanionic structure, and nontoxicity (Formula I), make it a potent candidate for the modification of bulk and surface properties of the TFC RO membranes. Creating a thin hydrophilic selective layer by incorporating the Lignin into the RO membrane structure exhibits enhanced fouling resistance with improved permeation and rejection performance.

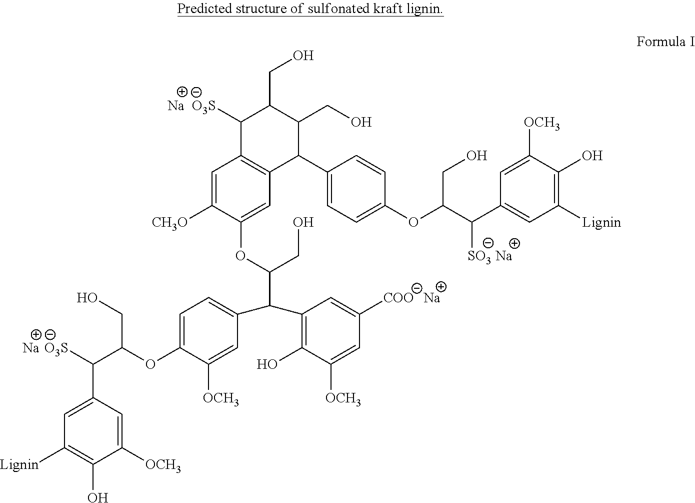

Modifying TFC RO membranes by incorporating biocide agents such as silver-based metal-organic frameworks is a promising approach to improving membrane properties and biofouling resistance. The appeal of this approach is mainly due to the ability of biocidal agents on membrane surfaces to deactivate bacteria upon contact. Ag-MOFs are promising antibacterial materials because their inorganic and organic components can provide platforms to generate strong bactericidal activity and biocompatibility. A major advantage of these MOFs is their ability to act as a reservoir of silver ions that are inherent parts of their molecular structure (Formula II). The formation of chemical bonds stabilizes the silver ions to the organic linker that is sufficiently strong to make the Ag-MOFs structure adequately robust without blocking their antibacterial activity. Another advantage of Ag-MOFs is their uniform distribution of silver active sites. Ag-MOFs provide a long-lasting antibacterial effect and prevent silver agglomeration due to their great affinity to polyamide chains. This feature provides an opportunity for improving the RO membrane's active layer properties without adverse effects on its selectivity (FIG. 10).

The membranes prepared according to the disclosure provide water transport at very high permeability while maintaining a high level of rejection of salts relative to the existing RO membranes. The membrane is thus resistant to fouling and the conditions of use. This is reflected in particular at the level of the synergistic increase in water permeability (4-6.5 LMH/bar) and NaCl rejection (>98.0%) and their antifouling properties. Preparing these new membrane materials is simple, inexpensive, and easy to scale up.

Accordingly, it would be an advance in the art of membrane science to provide improved membranes performance and fouling resistance for reverse osmosis application. The intended patent application covers the complete process of making high-performance TFC RO membrane, including i) the continuous process of fabrication of PSf porous substrate with adequate properties, ii) the fabrication process of hydrophilic polyamide selective layer containing hydrophilic green Lignin on the top of PSf porous support substrate and, iii) the fabrication process of antibacterial polyamide selective layer containing silver-based metal-organic framework on the top of PSf porous support substrate.

### SUMMARY

In some embodiments, methods are disclosed of fabricating high-performance thin film composite reverse osmosis membranes with outstanding antifouling and antibacterial properties for water desalination using Lignin as renewable additive and silver-based metal organic framework. The solution may at least provide a method of fabricating a membrane comprising sulfonated kraft lignin (SKL), a local pulp mill waste product, to enhance the perm-selectivity and silver-based metal-organic framework to enhance the antibacterial properties of TFC RO membranes. In some embodiments, methods are disclosed of fabricating PSf porous membranes in the range of ultrafiltration as substrate at the pilot scale of 300 cm width×50 length at the rate of 0.5-5 meters/min using the semi-automated casting machine. An ultrathin polyamide selective layer is prepared on the top of PSf porous substrate by interfacial polymerization between an aqueous diamine solution and TMC in the organic phase of n-hexane/co-solvent under a cost-efficient process.

TFC RO membranes developed according to this disclosure typically consist of at least two layers, (i) a top thin selective polyamide layer modified with hydrophilic or biocidal agents fabricated via interfacial polymerization, and (ii) a bottom microporous sublayer with different structures and materials having a woven/non-woven layer fabricated via non-solvent induced phase separation. The structure and properties of the selective and support layers can be individually tailored and optimized by utilization of material and chemical combinations in both aqueous and organic phases to achieve the desired separation capabilities and antifouling properties of thin film composite membranes. A polyamide selective layer is fabricated by the interfacial polymerization reaction of diamine agents (commonly piperazine for semi-aromatic and m-phenylenediamine for fully aromatic polyamide) in the range 1-3 (w/w %) in the presence of various additives such as hydrophilic Lignin and TMC in the range of 0.05-0.2% (w/v %) in the presence of co-solvent. The condensation reaction of polyfunctional acyl halides and diamines is performed by placing the reactants in two immiscible phases where polymerization occurs only at the interface of the two immiscible phases on the top of the porous support membrane. The post-treatment of pristine TFC membrane is then carried out with glycerin (in the range of 5-20 w/v %) and/or polyvinyl alcohol (PVA, 0.5-2 w/v %).

The preferred option for the support layer polymer includes PSf embedded with polyvinylpyrrolidone (PVP) as a pore former. A polyester non-woven fabric is also incorporated into the PSf support layer to improve the handling properties of the membranes. Briefly, in the present disclosure, modified thin film composite reverse osmosis membranes with high flux and salt rejection performance were developed in which comprising the steps of;
Providing flat sheet PSf porous support on a polyester non-woven fabric vis nonsolvent induced phase separation (NIPS) method; and
providing TFC polyamide membrane having PSf porous support on a non-woven polyester fabric coated with one amine monomer (m-phenylene diamine, MPD) and acid chloride monomer (trimesoyl chloride, TMC) via interfacial polymerization method, in which the porous substrate is contacted with an aqueous MPD monomer solution and a TMC organic monomer solution to form a selective polyamide layer embedding with the Lignin and silver-based metal-organic frameworks.

According to embodiments of the disclosure, membranes and/or membrane elements have various applications, including water and wastewater treatment, water softening, and seawater desalination using a reverse osmosis apparatus comprising RO membranes, as described herein. Such applications are expected in different industries, such as oil and gas, pulp and paper, mining, and agriculture industries.

A method of making a high-performance thin-film composite membrane method comprising: (i) preparing a polysulfone (PSf) support membrane by: (a) dissolving PSf in dimethylformamide (DMF) so as to form a uniform solution; (b) maintaining a concentration of polyvinylpyrrolidone in the uniform solution at a range of 0.5-3.0 wt % by adding one or more solvents; (c) degassing the solution, and thereafter casting the solution on a 90-110-micron thick nonwoven polyester support while maintaining a cast thickness at about 0.12 microns to form a cast film; (d) immediately immersing the cast film in a water precipitation bath and initiating phase separation; (e) removing the one or more solvents, and thereafter treating the formed support membrane with ethanol followed by hexane; (ii) contacting the formed support membrane with an aqueous diamine solution comprising 1-3% w/v MPD, 0.5-5% w/v dimethyl sulfoxide, 0.5-2% v/v triethylamine, 0.5-2% w/v camphor sulfonic acid, and 0.01-0.2% w/v surfactant (0.01-0.2% w/v sodium dodecyl sulfate, 0.01-0.5 Triton x-100 (C₁₄H₂₂O(C₂H₄O)ₙ), or 0.01-0.5 Tween 80 (C₆₄H₁₂₄O₂₆)), for a time period of about 120 seconds; (iii) removing excess aqueous diamine solution from the support surface; (iv) gently pouring an organic solution containing 0.15% w/v TMC and 5-15% v/v co-solvent in hexane on the support surface and initiating an interfacial polymerization reaction; (v) draining the organic solution from the support surface, and heating the support surface and membrane formed thereon at about 80° C. for about 5 minutes in absence of exposure to the atmosphere; and (vi) washing the formed membrane and support layer.

A high performance thin-film composite membrane comprising a multilayer permeable structure that comprises: a polysulfone (PSf) support membrane layer with a thickness of 90-110 microns; and a selective layer that comprises a polyamide made of diamine and trimesoyl chloride, and that has a thickness of less than or equal to 200 nm.

In various embodiments, there may be included any one or more of the following features: The co-solvent comprises one or more of chloroform and DMF. The high performance thin-film composite membrane has high-salt-selectivity (>98% of NaCl). Step (i)(a) comprises dissolving 14-16% polysolfone in dimethylformamide so as to form the uniform solution. Step (i)(c) comprises degassing the solution, and thereafter casting the solution on a 100-micron thick nonwoven polyester support. Step (b) further comprises adding one or more solvents of one or more of N-methyl-2-pyrrolidone, Dimethylsulfoxide, DMF, and Dimethylacetamide. The aqueous diamine solution from step (ii) comprises a co-solvent of one or more ethanol and acetone. Step (iii) further is carried out after 30-180 seconds. Step (iv) further comprises 10% v/v co-solvent of one or more of chloroform and DMF in hexane on the support surface and initiating the interfacial polymerization reaction thereon to form a polyamide selective layer on the support surface. Step (v) is carried out after 30-90 seconds. Contacting, in step (ii) comprises spraying or pouring. An anti-microbial metal organic framework to reduce fouling of the membrane, and further comprising: (1) preparing an aqueous silver nitrate solution; (2) preparing a ligand solution comprising 2-imidazole dissolved in an alcohol, at a ratio of approximately 0.3 g-0.5 g of 2-imidazole per 90 mL of alcohol; (3) adding the ligand solution to the silver nitrate solution; and (4) recovering and drying a formed precipitate that comprises an anti-microbial metal organic framework; in which, before step (ii) is carried out, adding the anti-microbial metal organic framework to the aqueous diamine solution. The ligand solution of step (2) comprises 2-imidazole dissolved in an alcohol, at a ratio of 0.3 g of 2-imidazole per 90 mL of alcohol. Before contacting in step (ii), mixing the aqueous diamine solution with a lignin solution containing 0.5-5 wt % of a hydrophilic lignin. The aqueous diamine solution in step (ii) comprises 0.2 wt % sodium dodecyl sulfate (SDS). The hydrophilic lignin comprises a sulfonated kraft lignin. The sulfonated kraft lignin is a by-product produced during the delignification of lignocellulose in the paper-making process. The sulfonated kraft lignin has the structural configuration of Formula I. In step (ii), contacting comprises pouring the aqueous diamine solution. In step (1)(c), casting the solution on the nonwoven polyester support is conducted using a semi-continuous casting machine. An anti-microbial metal organic framework to reduce fouling of the membrane, and further comprising: (1) preparing an aqueous silver nitrate solution; (2) preparing a ligand solution by dissolving 2-imidzalone in an alcohol; (3) adding the ligand solution to the silver nitrate solution; and (4) recovering and drying a formed precipitate that comprises an anti-microbial metal organic framework; in which, before step (ii) is carried out, adding the anti-microbial metal organic framework to the aqueous diamine solution. The alcohol in step (2) comprises ethanol. Contacting, in step (ii) comprises pouring. The anti-microbial metal organic framework is added to the aqueous diamine solution at an amount of 0.05-0.1 wt %. The step of, before contacting in step (ii), mixing the aqueous diamine solution with a lignin solution containing 0.5-5 wt % of a hydrophilic lignin. The hydrophilic lignin comprises a green lignin. The hydrophilic lignin comprises a sulfonated kraft lignin. A high performance thin-film composite membrane made by carrying out the method. The surfactants comprise one or more of sodium dodecyl sulfate, Triton x-100 (C₁₄H₂₂O(C₂H₁₄O)ₙ), or Tween 80 (C₆₄H₁₂₄O₂₆). The surfactants comprise one or more of Triton x-100 (C₁₄H₂₂O(C₂H₄O)ₙ), or Tween 80 (C₆₄H₁₂₄O₂₆). The structure of the polyamide incorporates an anti-microbial metal organic framework. The anti-microbial metal organic framework incorporates silver. An anti-microbial effect of five colony forming units (CFU) or less determined by a membrane filter test. The structure of the polyamide incorporates a hydrophilic lignin. The membrane is structured to reduce fouling of the membrane with a flux decline of equal to or less than 10% over 24 hr in a long term performance test. The sulfonated kraft lignin has the structural configuration of Formula I. The membrane is structured for brackish water reverse osmosis with a water permeability of 2.39 LMH/bar or higher. The membrane is structured for sea water reverse osmosis with a water permeability of 0.68 LMH/bar or higher.

The foregoing summary is not intended to summarize each potential embodiment or every aspect of the subject matter of the present disclosure. These and other aspects of the device and method are set out in the claims.

### BRIEF DESCRIPTION OF THE DRAWINGS FIGURES

Embodiments will now be described with reference to the figures, in which like reference characters denote like elements, by way of example, and in which:

FIG. 1A is a schematic view of a system for fabricating a flat sheet polysulfone (PSf) membrane as a substrate for a polyamide layer.

FIG. 1B is a schematic view of a procedure for the preparation of thin composite hydrophilic and antibacterial membranes.

FIG. 2A is a scanning electron microscopy (SEM) image of a surface of a sample support membrane.

FIG. 2B is a scanning electron microscopy image of a cross-section of the sample support membrane of FIG. 2A.

FIG. 3A is a scanning electron microscopy image of a surface of a high-performance thin film composite brackish-water reverse osmosis membrane.

FIG. 3B is a scanning electron microscopy image of a cross-section of the high-performance thin film composite brackish-water reverse osmosis membrane of FIG. 3A.

FIG. 3C is a scanning electron microscopy image of a surface of a high-performance thin film composite seawater reverse osmosis membrane.

FIG. 3D is a scanning electron microscopy image of a cross-section of the high-performance thin film composite seawater reverse osmosis membrane of FIG. 3C.

FIG. 4A is a scanning electron microscopy image of a surface of the support membrane with a 14 wt % of polymer.

FIG. 4B is a scanning electron microscopy image of a surface of the support membrane with a 15 wt % of polymer.

FIG. 4C is a scanning electron microscopy image of a surface of the support membrane with a 15.5 wt % of polymer.

FIG. 4D is a scanning electron microscopy image of a cross-section of the the support membrane of FIG. 4A.

FIG. 4E is a scanning electron microscopy image of a cross-section of the support membrane of FIG. 4B.

FIG. 4F is a scanning electron microscopy image of a cross-section of the support membrane of FIG. 4C.

FIG. 5A is a transmission electron microscopy image of a selective layer thickness of a high-performance thin film composite reverse osmosis membrane prepared with GRE-RO-55.

FIG. 5B is a transmission electron microscopy image of a selective layer thickness of a high-performance thin film composite reverse osmosis membrane prepared with GRE-RO-108DS.

FIG. 5C is a transmission electron microscopy image of a selective layer thickness of a high-performance thin film composite reverse osmosis membrane prepared with GRE-RO-103DS.

FIG. 5D is a transmission electron microscopy image of a selective layer thickness of a high-performance thin film composite reverse osmosis membrane prepared with GRE-RO-151.

FIG. 5E is a transmission electron microscopy image of a selective layer thickness of a high-performance thin film composite reverse osmosis membrane prepared with GRE-RO-53S.

FIG. 6A is a scanning electron microscopy image of a surface of an unmodified thin film composite reverse osmosis membrane, with an enlarged view in dashed lines.

FIG. 6B is a scanning electron microscopy image of a surface of a thin film composite reverse osmosis membrane with 0.5 wt % Lignin incorporated into the membrane, with an enlarged view in dashed lines.

FIG. 6C is a scanning electron microscopy image of a surface of a thin film composite reverse osmosis membrane with 2 wt % Lignin incorporated into the membrane, with an enlarged view in dashed lines.

FIG. 6D is a scanning electron microscopy image of a surface of a thin film composite reverse osmosis membrane with 5 wt % Lignin in a diamine solution incorporated into the membrane, with an enlarged view in dashed lines.

FIG. 7A is a graphical representation illustrating the water flux and rejection of an unmodified thin film composite reverse osmosis membrane.

FIG. 7B is a graphical representation illustrating the water flux and rejection of a Lignin-modified thin film composite reverse osmosis membrane.

FIG. 8A is a scanning electron microscopy image of a synthesized silver-based metal-organic framework.

FIG. 8B is a graphical representation illustrating an energy dispersive X-ray analysis of a synthesized silver-based metal-organic framework.

FIG. 8C is a transmission electron microscopy image of a synthesized silver-based metal-organic framework.

FIG. 8D is a graphical representation of an X-ray diffraction analysis of a synthesized silver-based metal-organic framework.

FIG. 9A is a scanning electron microscopy image of an antibacterial membrane before a filtration test, with an enlarged view in dashed lines.

FIG. 9B is an image illustrating the energy dispersive X-ray mapping analysis of the antibacterial membrane of FIG. 9A.

FIG. 9C is a scanning electron microscopy image of the antibacterial membrane after a filtration test, with an enlarged view in dashed lines.

FIG. 9D is an image illustrating the energy dispersive X-ray mapping analysis of the antibacterial membrane of FIG. 9C.

FIG. 10 is an illustrated view of the structure of a silver-based metal organic framework.

### DETAILED DESCRIPTION

Immaterial modifications may be made to the embodiments described here without departing from what is covered by the claims.

To produce a TFC RO membrane with adequate properties and performance, several parameters influencing the membrane structure and properties should be optimized at each stage. Machine design, chemistry, and engineering parameters have been optimized, allowing the technology to be implemented immediately at large commercial-scale production levels. The complete preparation of reverse osmosis membrane involves support membrane preparation, coating the substrate with ultrathin polyamide active layer via interfacial polymerization, washing, and finally, post-treatment to improve the antifouling property. The present disclosure provides a process for preparing high-performance TFC RO membranes with improved fouling resistance and antibacterial properties in two steps using the laboratory's simple machinery to produce membranes continuously.

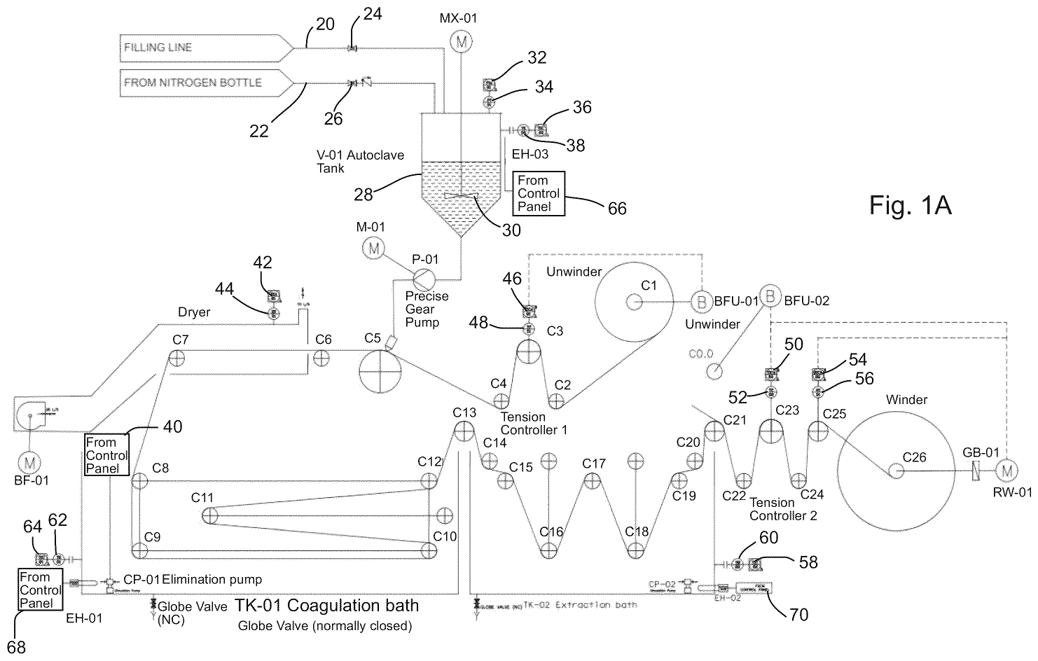

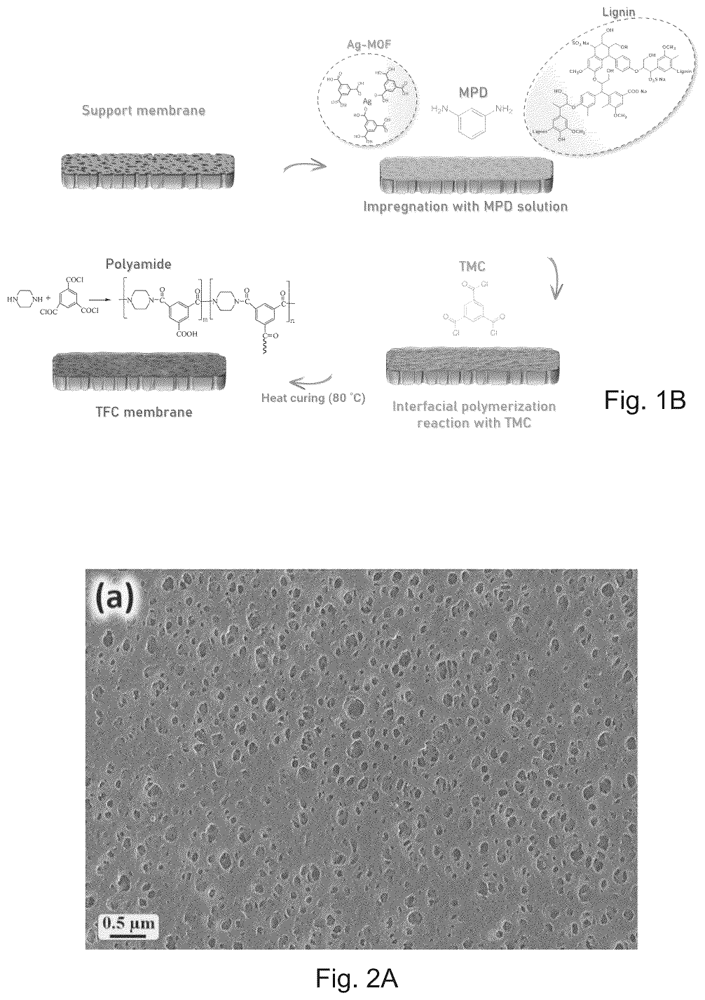

A method of making a high-performance thin-film composite membrane is disclosed. A first step in the method may comprise preparing a polysulfone (PSf) support membrane. The first step in the process is the preparation of PSf porous support membrane having about 50-micron thickness on the non-woven polyester fabric (100-micron thickness) using a semi-automated casting machine (FIG. 1a). The PSf porous support membrane is prepared according to non-solvent induced phase inversion method at a scale of 300 mm width and 50 m length at the rate of 0.5-5 m/min. The PSf support membranes used as support for TFC membranes are prepared from 14-16 wt % PSf solution with 0.5-3% polyvinylpyrrolidone as a pore-former additive. The molecular weight cutoff (MWCO) of PSf support membrane can be from 10 to 250 kD, preferably from 10 to 40 kD, or more preferably from 20 to 35 kD, with an MWCO point value of 20 kD. The thickness of the support may be of the order of 50 to 200 μm, for example, from 50 to 70 μm for porous support of PSF and from 50 to 130 um for support of polyester or polypropylene.

The pure water permeability of the PSf support membranes can be considered in the range between 750 and 1600 LMH/bar with an average amount of 750 LMH/bar for the fabrication of asymmetric RO membranes for seawater and brackish water desalination and 1600 LMH/bar for the fabrication of TFC polyamide RO membranes for brackish water and tap water filtration. The membrane may be structured for brackish water reverse osmosis with a water permeability of 2.30 LMH/bar or higher. The membrane may be structured for sea water reverse osmosis with a water permeability of 0.68 LMH/bar or higher.

The pure water permeability of PSf support membranes prepared following the method described in the present disclosure were in range of 880-1250 LMH/bar at cross flow velocity of 2 lpm.

Thin film composite polyamide active layers of about 100-200 nm thickness are then fabricated on the PSf porous membrane by in-situ interfacial polymerization of diamine (MPD) in water containing dimethyl sulfoxide, triethylamine, camphor sulfonic acid and sodium dodecyl sulfate, and hydrophilic Lignin additives, and TMC in hexane containing 5-15% co-solvent under optimized conditions, followed by heat curing at 80° C. for 3-10 min (FIG. 1b). The co-solvent may comprise one or more of chloroform and DMF.

The present disclosure further provides the process of making the antibacterial TFC RO membranes by incorporating the selective polyamide layer with silver-based metal-organic frameworks to mitigate the biofouling formation on the membrane surface.

Thin film composite RO membranes prepared following the method described in the present disclosure are capable of producing 60-110 LMH flux and 95.5-99.2% rejection when filtering the aqueous salt solution containing 2000 ppm of NaCl at the pressure of 225 psi and temperature of 26±1° C.

The present disclosure also relates to the development of a RO membrane for use in seawater desalination that is capable of producing potable water without the need for a subsequent stage of membrane polishing, delivering water at an adequate flow rate of 50-60 LMH, and rejecting NaCl at a rate of greater than 98.5% while operating at an operating pressure of 800 psi and temperature of 26±2° C.

Approach to measure the water flux, permeability, and solute rejection. The membranes were immersed in water for 10 minutes before conducting the filtration experiments with a cross-flow laboratory system comprising of a high-pressure pump (Hydra-cell pump, Wanner Engineering, Inc., Minneapolis), a 10-liter feed tank, a membrane cell, a system to control the temperature and data acquisition, flowmeters, valves, and a back pressure regulator. After loading the membrane samples (5*5 cm) in the cell and running the filtration setup, the membranes were compacted for an hour at a pressure of 225 bar and constant cross-flow of 4 lpm. Then the water flux was calculated by dividing the volumetric level of permeate collected for at least 2 hrs by the surface area of the membrane. The pH of the feed solution is adjusted to 7.5-7.7 with sodium bicarbonate and NaOH. The permeate flow rate was measured automatically for every 30 s using a balance with a computer interface, and the feed water temperature was kept constant at 26° C. for all experiments. The water permeability coefficient of membranes was calculated by dividing the water flux to the pressure applied to the system in bar. The observed value of solute rejection was calculated from the solute concentrations in the feed and permeate streams. The feed stream consisted of 2000-3000 ppm of NaCl for filtration at 225 psi (and 35000 ppm of NaCl for filtration 800 psi). The solute concentrations in the feed and permeate streams were obtained from the electrical conductivity measured using a calibration line.
The following description provides greater detail relating to embodiments of the invention. The table of contents is given by:
Section A provides greater detail and examples relating to general principles of the approach to fabricate the flat sheet PSf support membrane with a semi-automatic system.
Section B relates to fabricating a selective polyamide layer on PSf support membrane for brackish- and sea-water desalination.
Section C describes the approach of making antibacterial thin film nanocomposite (TFN) polyamide RO membranes.
Example 1 relates to fabricating flat sheet membranes according to the present approach, which will be used as a substrate to prepare TFC RO membranes.
Example 2 relates to the fabrication of TFC RO membranes with the polyamide selective layer according to the present approach for brackish water desalination.
Example 3 relates to the fabrication of TFC RO membranes with the polyamide selective layer according to the present approach for seawater desalination.
Example 4 relates to the fabrication of hydrophilic TFC RO membranes incorporated with hydrophilic Lignin according to the present approach for water desalination.
Example 5 relates to the fabrication of antibacterial TFC RO membranes incorporated with synthesized silver-based metal-organic frameworks according to the present approach for water desalination.

### Section A. Approach of Making Porous Membranes as a Substrate for TFC Polyamide Layer.

Preferred material options for the support layer include PSf and polyethersulfone (PES) polymers, which offer several advantages such as (1) excellent membrane formability and flexibility, (2) enhanced structural stability, and (3) appropriate hydrophobicity resulting in the formation of thin polyamide layer on the support. Preparing the PSf support membrane may comprise dissolving 14-16% polysolfone in dimethylformamide so as to form the uniform solution. Preparing the PSf support membrane may comprise dissolving the PSf in dimethylformamide (DMF) so as to form a uniform solution. To make the support membrane with non-solvent induced phase inversion, dope solutions containing 14-16 wt % of polymers (PSf) were prepared by dissolving in Dimethylformamide (DMF) at 60° C. under constant stirring at 500 rpm for 4-6 hrs. Preparing the PSf support membrane may comprise maintaining a concentration of polyvinylpyrrolidone in the uniform solution at a range of 0.5-3.0 wt % by adding one or more solvents. The one or more solvents may be used to prepare the polymer solutions, may include one or more of N-methyl-2-pyrrolidone, Dimethylsulfoxide (DMSO), DMF, and Dimethylacetamide (DMAc). Other solvents that could be used to prepare polymer solutions are N-methyl-2-pyrrolidone (NMP), and Dimethylacetamide (DAMc). Preparing the PSf support membrane may comprise degassing the solution, and thereafter casting the solution on a 90-110-micron thick nonwoven polyester support while maintaining a cast thickness at about 0.12 microns to form a cast film. The polymer solution was then put in an oven for at least 1 hr to remove the air bubbles before casting. Once the solution is degassed, the solution may be cast on a 100-micron thick nonwoven polyester support. The PSf solution was cast on about 100 microns thick moving nonwoven polymer support at 1-2 m/min casting speed using a semi-automated continuous membrane casting unit according to the non-solvent induced phase inversion process. The casting film thickness was adjusted precisely by maintaining a gap between the casting blade and fabric support in the range 110-120 μm with the digital depth micrometers attached at both ends of the casting knife. Preparing the PSf support membrane may comprise, immediately after forming the cast film, immersing the cast film in a water precipitation bath and initiating phase separation. The cast film in the example was immediately immersed in a water precipitation bath at temperature of about 30° C. to initiate the phase separation. Preparing the PSf support membrane may comprise removing the one or more solvents, and thereafter treating the formed support membrane with ethanol followed by hexane. The membrane in the example was allowed to remain in the precipitation bath for 1 hr until the solvent and additives present in the polymer solution are completely removed. After washing, the fabricated porous membrane was further post-treated by putting in ethanol solution followed by n-hexane solution for 10 min to prevent surface pore damage. Casting the solution on the nonwoven polyester support may be conducted using a semi-continuous casting machine. An example machine arrangement for making PSf support membrane is shown in FIG. 1. The casting machine consists of: (i) unwinding system to release the nonwoven fabric in order to cast the dope solution on it, (ii) casting unit to cast the polymeric dope solution, uniformly, on the surface of polyester substrate, (iii) a tank for gelation bath, and (iv) guiding rollers at appropriate places, and (v) winding system to collect the fabricated membranes on designated roller that is connected to a motor which in turn is interfaced with a computer controlled device that is capable of maintaining the set speed throughout the process. Table 1 lists the various parts of the casting machine shown in FIG. 1A.

TABLE 1
part numbers in FIG. 1A

| reference number | part |
|---|---|
| C0 and C1 | Unwinder |
| C2-C4, C22-C24, 48 and 52 | Tension Control |
| C5-C21 and C25 | Casting Drum |
| C26, RW-01 | Winder |
| MX-01 and M-01 | Mixer |
| V-01 | Autoclave Tank |
| EH-01, EH-02 and EH-02 | Electrical Heater |
| P-01, CP-01 and CP-02 | Water Circulation Pump |
| BF-01 | Blower Fan |
| TK-01 | Coagulation Bath |
| TK-02 | Extraction Bath |
| GB-01 | Gear Box |
| BFU-01, BFU-02 | Unwinder Brake |
| 20 | Filling line |
| 22 | Line from Nitrogen Bottle |
| 24 and 26 | Valve |
| 28 | Dope Solution Tank |
| 30 | Stirrer |
| 32 | Pressure Indicating Alarm |
| 34 | Pressure Transmitter |
| 36, 58 and 64 | Temperature Indicator |
| | Controller |
| 38, 60 and 62 | Temperature Element |
| 40, 66, 68 and 70 | Heating Control Panel |
| 42 | Humidity Indicating Alarm |
| 44 | Humidity Transmitter |
| 46 and 50 | Tension Indicating and Control |
| | Apparatus |
| 54 | Speed Indicating and Control |
| | Apparatus |

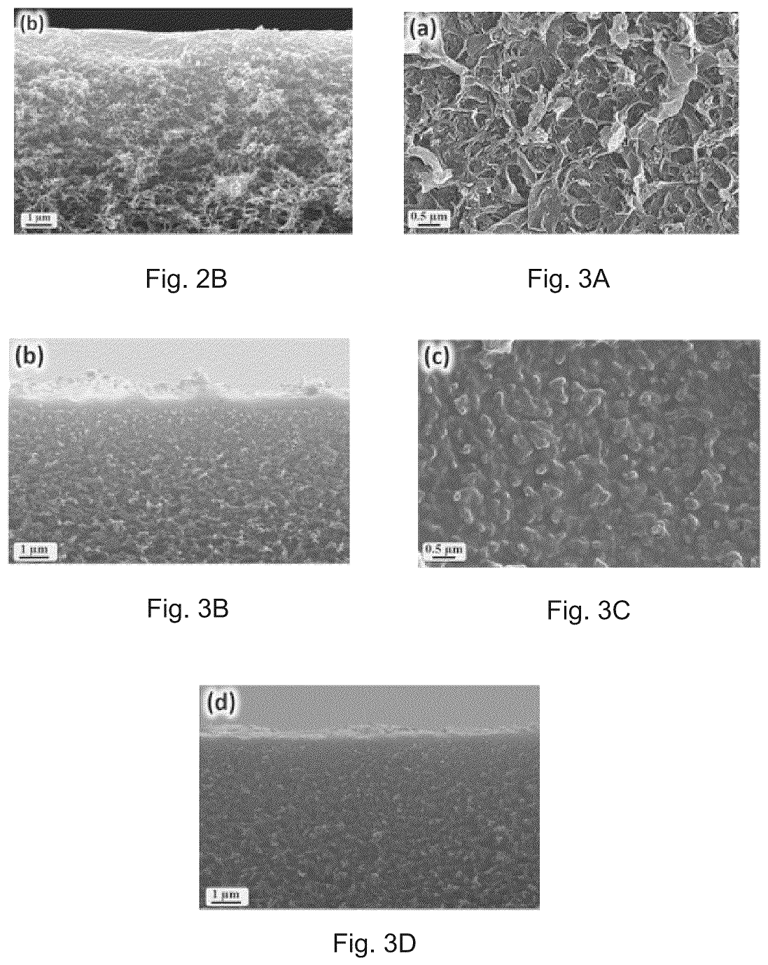

An exemplary membrane structure, shown on FIG. 2, includes a microporous (preferably 1-3 μm thick) barrier layer on top of a (preferably 40-50 μm) porous support layer (both PSf and non-woven polymer). The non-woven polymer is also used at the bottom of PSf layer to provide the membranes' mechanical stability and handling capability, also allowing for an increased ΔP across the membrane which assists in improving flux rates, without significantly negatively affecting the membrane separation performance. The porosity and weight of the non-woven support for the fabrication of RO membrane are about 4.2 cfm/ft² and 85 gsm, respectively.

### Section B. Approach of Making TFC Polyamide RO Membranes.

Another embodiment of this disclosure is making high-performance thin film composite membranes for RO applications. The high-performance thin-film may have a high-salt-selectivity, for example >98% of NaCL (sodium chloride). These RO membranes have a composite structure, which includes a rough surface and a thin selective layer on the surface of the porous support layer. A high performance thin-film composite membrane may comprise a multilayer permeable structure. The multilayer permeable structure may comprise a polysulfone (PSf) support membrane layer with a thickness of 90-110 microns and a selective layer that comprises a polyamide made of diamine and trimesoyl chloride, and that has a thickness of less than or equal to 200 nm, in which the polyamide has a structure that incorporates surfactants and/or Lignin. The surfactants may comprise one or more of sodium dodecyl sulfate, Triton x-100 (C₁₄H₂₂O(C₂H₄O)ₙ), or Tween 80 (C₆₄H₁₂₄O₂₆). The structure of the polyamide may incorporate an anti-microbial metal organic framework. The support membrane layer can be fabricated with hydrophobic polymer(s), such as PSf, with or without incorporating additives by non-solvent induced phase inversion method. The thin selective polyamide layer can be synthesized on one surface of the support membrane by interfacial polymerization. FIG. 3 shows an example where the polyamide rejection layer is formed on the surface of the support layer. Specifically, the material of the polyamide selective layer is a polymer with R1-C(═O)—NH—R2 linkages that is formed by polymerization between one or more di- or polyfunctional amines and one or more di- or polyfunctional acyl chlorides. This polymerization is preferably interfacial polymerization as described in more detail below. The di- or polyfunctional amines can be aromatic and/or aliphatic. The di- or polyfunctional acyl chlorides can be aromatic and/or aliphatic. The preferred material options for di- or polyfunctional amines include MPD, and piperazine, while the preferred material options for di- or polyfunctional acyl chlorides include TMC and Isophthaloyl dichloride (IPC).

The method of making the high-performance thin-film composite membrane may comprise contacting the formed support membrane with an aqueous diamine solution. Diamine solution was prepared by dissolving 1-3% w/v MPD, 0.5-5.0% w/v dimethyl sulfoxide (DMSO), 0.5-2% v/v triethylamine, 0.5-2% w/v camphor sulfonic acid and surfactant (0.01-0.2% w/v sodium dodecyl sulfate or 0.01-0.5 Triton x-100 (C₄H₂₂O(C₂H₄O)ₙ) or 0.01-0.5 Tween 80 (C₆₄H₁₂₄O₂₆)) in water with and without different concentrations of ethanol, acetone, and hydrophilic Lignin. Acid chloride solution was prepared by dissolving 0.1-0.4% w/v TMC and 5-15% v/v co-solvents in hexane. Polyamide thin film coating was carried out by interfacial polymerization. The diamine in an aqueous solution was reacted with acid chloride in hexane at the aqueous-organic interface to form a thin polyamide film. The method of making the high-performance thin-film composite membrane may comprise contacting the formed support membrane with an aqueous diamine solution comprising 1-3% w/v MPD, 0.5-5% w/v dimethyl sulfoxide, 0.5-2% v/v triethylamine, 0.5-2% w/v camphor sulfonic acid, and 0.01-0.2% w/v surfactant (0.01-0.2% w/v sodium dodecyl sulfate, 0.01-0.5 Triton x-100 (C14H22O(C2H4O)n), or 0.01-0.5 Tween 80 (C64H124O26)), for a time period of 30-180 seconds. The PSf support was exposed to the roller and air to remove any visible water from the surface, before contacting to amine solution to ensure that a very thin layer of amine solution was obtained on the PSf support surface. The method of making the high-performance thin-film composite membrane may comprise gently pouring an organic solution, which may contain 0.15% w/v TMC and 5-15% v/v co-solvent in hexane on the support surface and initiating an interfacial polymerization reaction. The TMC solutions may be applied on a drained PSf surface for a sufficient amount of time, for example, 30-90 sec. The organic solution may be drained from the support surface, and the support surface and membrane formed thereon may be heated at about 80° C. for about 5 minutes. During this period, the amine monomer presented on the support surface started to react with TMC in hexane at the aqueous-organic interface, forming the polyamide thin selective layer. After completing the interfacial polymerization, the nascent thin film composite membranes were heat cured in an oven at 80° C. for 5-10 min without extra exposure to the atmosphere. The method of making the high-performance thin-film composite membrane may comprise washing the formed membrane and support layer. In the final step, the surface of the composite membrane was washed with water to remove the unreacted material and covered by glycerin (5-20 wt %) until used for the filtration test. In some cases, the rinsing step has been added to the final stage to ensure the complete removal of unreacted reagents. The rinsing may be carried out in an aqueous solution of 200 ppm NaOCl (for 120 sec) and/or 1000 ppm NaS₂O₅ (for 30 sec), followed by immersing in deionized water at 80° C. for 120 sec. The post-treatment of pristine TFC membrane is then carried out with glycerin (in the range of 5-20 w/v %) and/or polyvinyl alcohol (PVA, 0.5-2 w/v %).

### Section C. Approach of Making Antibacterial Thin Film Nanocomposite (TFN) Polyamide RO Membranes.

Another embodiment of this disclosure is making antibacterial TFC membranes for RO applications by incorporating Ag-MOFs into the thin selective polyamide layer. Silver-based MOFs are among the most promising alternative materials to make robust antibacterial materials because of the higher affinity, controlled release of biocidal agents, and improved compatibility with the polyamide chain compared to their fully inorganic counterparts. The homogenous distribution of active metal centers in their frameworks would offer a prolonged biocidal activity without aggregation or oxidation. The procedure of making antibacterial TFN RO membranes is the same as the procedure of making TFC RO membranes described in section B except for 0.005-0.05 wt % of silver-based metal organic frameworks were added to the diamine aqueous solution containing MPD, w/v dimethyl sulfoxide, triethylamine, camphor sulfonic acid and surfactants.

### Example 1: Preparation of PSf Support Membranes

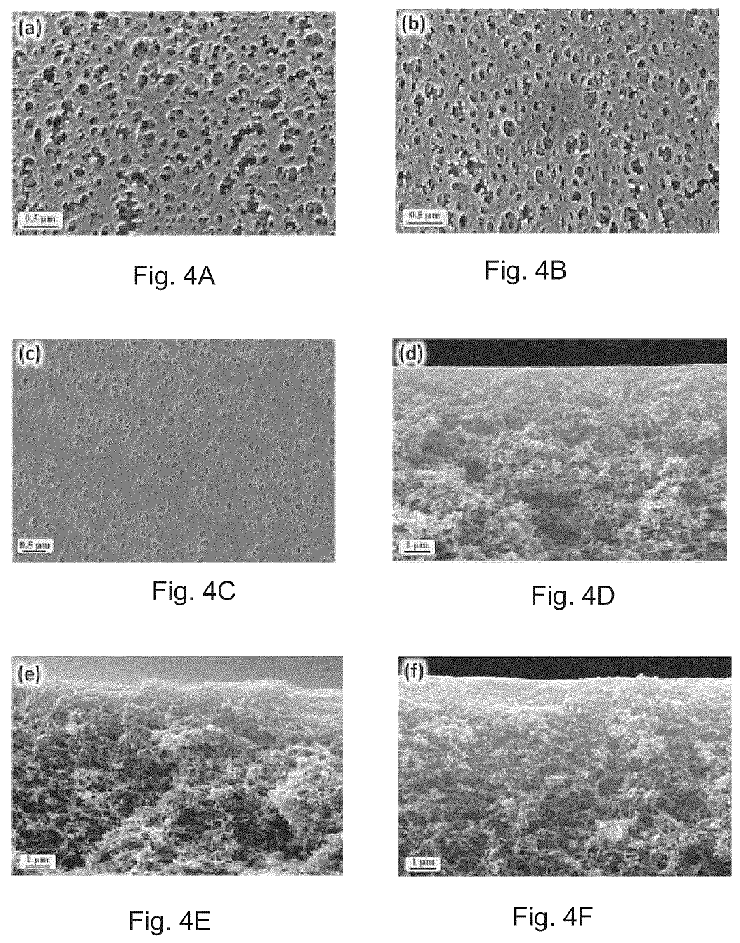

This example describes the preparation of support membranes according to the non-solvent induced phase separation approach as well as variations of this approach, allowing to tune the properties and characteristics of the support membranes. The dope solutions were prepared by dissolving 14-16 wt % PSf (Udel p3500) in dimethyl formamide at a temperature of 60° C. under a constant stirring rate of 500 rpm for at least 6 hours to form a uniform solution. Polyvinylpyrrolidone concentration in the casting solution was maintained at a range of 0.5-3.0 wt %. Some other solvents, such as N-methyl-2-pyrrolidone, Dimethyl sulfoxide, Dimethylformamide, and Dimethylacetamide were also used to prepare the casting solution. The polymer solution was stored in a desiccator for 3 hr and degassed in a vacuum oven before casting. The degassed solutions were cast on about 100 microns thick nonwoven polyester support with a semi-continuous casting machine. The cast thickness was maintained at 0.12 microns using the digital micrometers fixed at both ends of the casting blade. The cast film was immediately immersed in a water precipitation bath with a speed of 1-2 m/min at room temperature (25° C.) and humidity of 30% to initiate the phase separation. The fabricated support membrane remained in the rinsing water bath for at least 1 hr to complete the phase inversion process and remove the solvent and additive from the membrane structure. After fabrication, the support membrane was treated with ethanol for 10 min followed by hexane for 10 min to prevent damaging the structure of pores. The final thickness of the support membrane was about 150 microns. FIG. 4 depicts the surface and cross-sectional structure difference between membranes obtained from different polymer concentrations. Table 2 provides the characteristics and performance of the PSf support membrane fabricated with variations in the procedures described above. The pure water permeability of PSf support membranes prepared following the method described in the present disclosure was in the range of 880-1250 LMH/bar at cross-flow velocity of 2 lpm.

TABLE 2
Support membrane performance and properties.
(pure water and HA flux, HA removal,
100 ppm HA solution, ΔP = 20 psi)

| | Pure water | Pure water | HA water | HA |
|---|---|---|---|---|
| | flux | permeability | flux | removal |
| Membrane | (LMH) | (LMH/bar) | (LMH) | (%) |
| GRE-UF-1 | 1700 | 1250 | 370 | 94.0 |
| GRE-UF-2 | 1590 | 1169 | 340 | 94.1 |
| GRE-UF-3 | 1290 | 949 | 355 | 93.3 |
| GRE-UF-4 | 1270 | 934 | 336 | 94.6 |
| GRE-UF-5 | 1200 | 882 | 350 | 96.5 |

### Example 2: Preparation of Nanostructured High-Performance Thin Film Composite Polyamide RO Membranes for Desalination

This example describes the fabrication of thin film composite brackish-water reverse osmosis (BWRO) and seawater reverse osmosis (SWRO) membranes according to the interfacial polymerization approach as well as variations of this approach, allowing to tune the water flux and salt rejection of the membranes. It also shows a performance comparison of these membranes to several commercially available RO membranes.

Partially dried PSf membranes prepared following the procedure mentioned in Example 1 were mounted on frame support and a small amount of aqueous phase solutions was gently spread on them. The aqueous diamine compositions include 1-3% w/v MPD and 2-5% MPD (for SWRO), 0.5-5.0% w/v dimethyl sulfoxide, 0.5-2% v/v triethylamine (for BWRO and SWRO), 0.5-2% w/v camphor sulfonic acid (for BWRO and SWRO), and surfactant (0.01-0.2% w/v sodium dodecyl sulfate or 0.01-0.5 Triton x-100 (C₁₄H₂₂O(C₂H₄O)ₙ) or 0.01-0.5 Tween 80 (C₆₄H₁₂₄O₂₆) (for BWRO and SWRO)) in water. The aqueous diamine solution may comprise a co-solvent, such as one or more of ethanol and acetone. In some compositions, 5 and 10% v/v ethanol and acetone were also used as co-solvent in the aqueous solution. The aqueous diamine solution may contact the support membrane for a sufficient amount of time, for example between 30-180 seconds. After 30-180 sec of soaking time, the amine solution was drained from the support surface, and the remaining excess solution was squeezed entirely off by a roller and/or air knife. Subsequently, the organic solutions containing 0.1-0.4% w/v TMC and 5-15% v/v co-solvent (chloroform and DMF) in hexane are gently poured on the surface of amine-saturated PSf support with the reaction time of 30-90 sec. The organic solution may comprise 10% v/v co-solvent of one or more of chloroform and DMF in hexane on the support surface and may initiate the interfacial polymerization reaction thereon to form a polyamide selective layer on the support surface. During this interfacial polymerization stage, a polyamide selective layer is formed on the support surface. After completing the condensation polymerization reaction, the excess organic solution was drained off from the membrane surface. Thereafter, the membrane was put in the oven at 80° C. for 5 min without exposing it to the atmosphere to make the formed polyamide layer robust and tough. The heat-cured composite membranes were washed with water to remove the unreacted reagents and covered by glycerin (5-20 wt %) before using for the filtration test. In some cases, the additional rinsing steps, including rinsing with either water or an aqueous solution of 200 ppm NaOCl (for 120 sec) and/or 1000 ppm NaS₂O₅ (for 30 sec), followed by immersing in deionized water at 80° C. for 120 sec were also applied to heat-cured polyamide membranes to ensure the cross-linked structure and the complete removal of residual chemicals. The post-treatment of pristine TFC membrane is then carried out with glycerin (in the range of 5-20 w/v %) and/or polyvinyl alcohol (PVA, 0.5-2 w/v %).

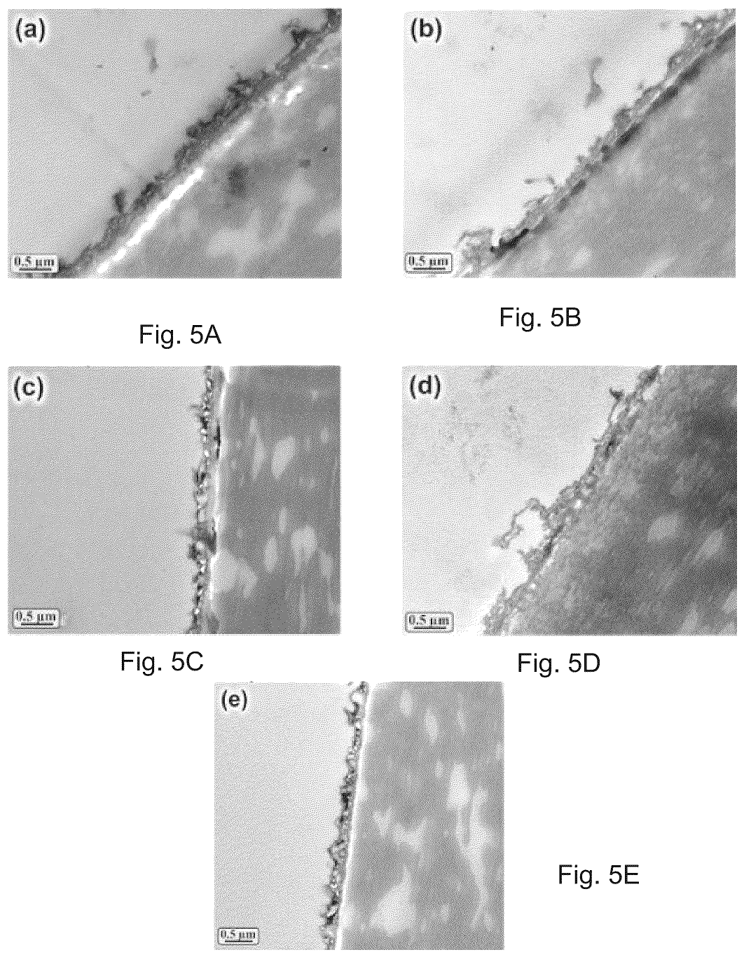

Tables 3 and 4 show the performance of various GRE-BWRO and GRE-SWRO membranes, respectively, prepared using the procedure described above in desalination tests compared to the performance of commercial RO membranes in the same test. FIG. 5 illustrates the cross section and selective layer thickness difference between BWRO membranes prepared with different compositions.

GRE-RO-DS membranes were prepared using the same procedure for the support preparation and interfacial polymerization, except 1-5 wt % DMSO and 0.05-0.2 wt % surfactant was added to the diamine solution. These membranes exhibit much higher water flux with no significant decrease in salt rejection than the GRE-RO-55 membrane without DMSO co-solvent in the diamine solution.

GRE-RO-49 membrane was prepared using the same procedure for the support preparation and interfacial polymerization, except the soaking time of the support membrane in the diamine solution was 30 sec. This membrane exhibits higher water flux and lower salt rejection than the GRE-RO-66D membrane with 2 min of soaking time in the diamine solution.

TABLE 3
TFC BWRO membrane performance and properties
(NaCl solution 2000 ppm, ΔP = 225 psi, Feed
velocity = 4 lpm, Temperature = 26° C.)

| | Water | Water | NaCl |
|---|---|---|---|
| | flux | permeability | Rejection |
| Membrane | (LMH) | (LMH/bar) | (%) |
| GRE-RO-55 | 46.5 | 2.39 | 98.60 |
| GRE-RO-108DS | 98.0 | 6.40 | 98.68 |
| GRE-RO-103DS | 101.5 | 6.63 | 98.45 |
| GRE-RO-109DS | 80.5 | 5.26 | 99.22 |
| GRE-RO-121DS | 78.0 | 5.10 | 97.38 |
| GRE-RO-49 | 58.50 | 3.82 | 97.55 |
| GRE-RO-151 | 91.0 | 4.18 | 98.58 |
| GRE-RO-76E | 66.0 | 4.31 | 97.47 |
| GRE-RO-77A | 55.0 | 3.59 | 98.20 |
| GRE-RO-53S | 75.5 | 4.93 | 99.10 |
| Suez-AG (Commercial) | 50.3 | 3.29 | 98.50 |
| Suez-AK (Commercial) | 126.0 | 8.23 | 95.10 |
| Dow-BW30 (Commercial) | 65.5 | 4.28 | 98.05 |

GRE-RO-76E membrane was prepared using the same procedure for the support preparation and interfacial polymerization, except 10 v % ethanol was added to the diamine solution. This membrane exhibits higher water flux and lower salt rejection than the GRE-RO-55 membrane without ethanol in the diamine solution.

GRE-RO-77A membrane was prepared using the same procedure for the support preparation and interfacial polymerization, except 10 v % acetone was added to the diamine solution. This membrane exhibits lower water flux and lower salt rejection than the GRE-RO-55 membrane without acetone in the diamine solution.

GRE-RO-53S membrane was prepared using the same procedure for the support preparation and interfacial polymerization, except the diamine solution was sprayed on the surface of the support membrane. This membrane exhibits significantly higher water flux and higher salt rejection than the TFC membrane prepared with the conventional soaking method.

Specifically, increased selectivity of the TFC will typically as a rule of thumb result in substantially reduced flux rates. For example, and as may be seen from Table 3 above, in the case of prior art TFC membrane such as Suez-AK (Commercial) having a rejection of 95.10% and a flux of 126 LMH, moving to a more selective membrane such as Suez-AG (Commercial) having an improved and more desired rejection of 98.5% unfortunately results in a substantially reduced flux rate of 50.3 LMH.

The present disclosure, however, one manifestation of which is contained in GRE-RO-108DS having a rejection of 98.68% and flux of 98.0 LMH, cannot only further improve selectivity over either Suez-AG and Suez-AK (Commercial) existing prior art TFC membranes and elevate such rejection to 98.68%, but further manages to avoid the extensive resulting decrease in flux as a penalty. By way of example, the GRE-RO-109DS membrane (with rejection of 99.22%) while having a higher selectivity than Suez-AG (Commercial) TFC membrane, nevertheless has been able to still achieve a respectable flux rate, namely a flux rate of 80.5 LMH which is approximately 55% higher than Suez AG.

TABLE 4
TFC SWRO membrane performance and properties
(NaCl solution 35000 ppm, ΔP = 800 psi, Feed
velocity = 6 lpm, Temperature = 26° C.)

| | Water | Water | NaCl |
|---|---|---|---|
| | flux | permeability | Rejection |
| Membrane | (LMH) | (LMH/bar) | (%) |
| GRE-SWRO-133 | 54.5 | 1.00 | 98.58 |
| GRE-SWRO-140 | 63 | 1.16 | 97.68 |
| GRE-SWRO-145 | 37 | 0.68 | 98.71 |
| Suez-SW (Commercial) | 26 | 0.48 | 98.60 |

GRE-SWRO membranes were prepared using the same procedure for the support preparation and interfacial polymerization, with 2.5-3.5 wt % MPD and 0.1-1 wt % DMSO in the aqueous solution. These membranes exhibit much higher water flux with no significant decrease in salt rejection compared to commercial Suez-SW membrane.

### Example 3: Preparation of Hydrophilic Thin Film Composite Polyamide RO Membranes Incorporated with Hydrophilic Lignin for Desalination

The preparation procedure of these hydrophilic RO membranes is similar to Example 2, except that the diamine aqueous solution was incorporated with 0.5-5 wt % of hydrophilic Lignin to modify the surface properties of TFC polyamide RO membranes. Lignin which is the second most abundant renewable natural polymer source and is mainly produced as a by-product at an industrial scale during the delignification of lignocellulose in the paper-making process holds great potential for the modification of bulk and surface properties of the TFC membranes due to its inherent hydrophilicity, polyanionic structure, biodegradability, low cost, and nontoxicity. Lignin can be transformed from a traditional low-value waste product with a low range of applications to functional membrane materials with high application prospects. To prepare Lignin-modified TFC RO membranes, the aqueous diamine solutions comprising of 1-3% w/v MPD, 0.5-5% w/v dimethyl sulfoxide, 0.5-2% v/v triethylamine, 0.5-2% w/v camphor sulfonic acid and surfactant (0.01-0.2% w/v sodium dodecyl sulfate or 0.01-0.5 Triton x-100 (C₁₄H₂₂O(C₂H₄O)ₙ) or 0.01-0.5 Tween 80 (C₆₄H₁₂₄O₂₆)), and 0.5-5% Lignin were poured on the surface of PSf substrate for 120 sec. After wiping off the excess diamine solution from the support surface, the organic solution containing 0.15% w/v TMC and 10% v/v co-solvent in hexane are gently poured on the surface of amine-saturated PSf support for 60 sec to initiate the interfacial polymerization reaction. After completing the reaction, the organic solution was drained off from the membrane surface. Then the membrane was put in the oven at 80° C. for 5 min without exposing it to the atmosphere to make the polyamide layer robust and tough. The heat-cured composite membranes were washed with water to remove the unreacted reagents before using them for the filtration test. The post-treatment of pristine TFC membrane is then carried out with glycerin (in the range of 5-20 w/v %) and/or polyvinyl alcohol (PVA, 0.5-2 w/v %).

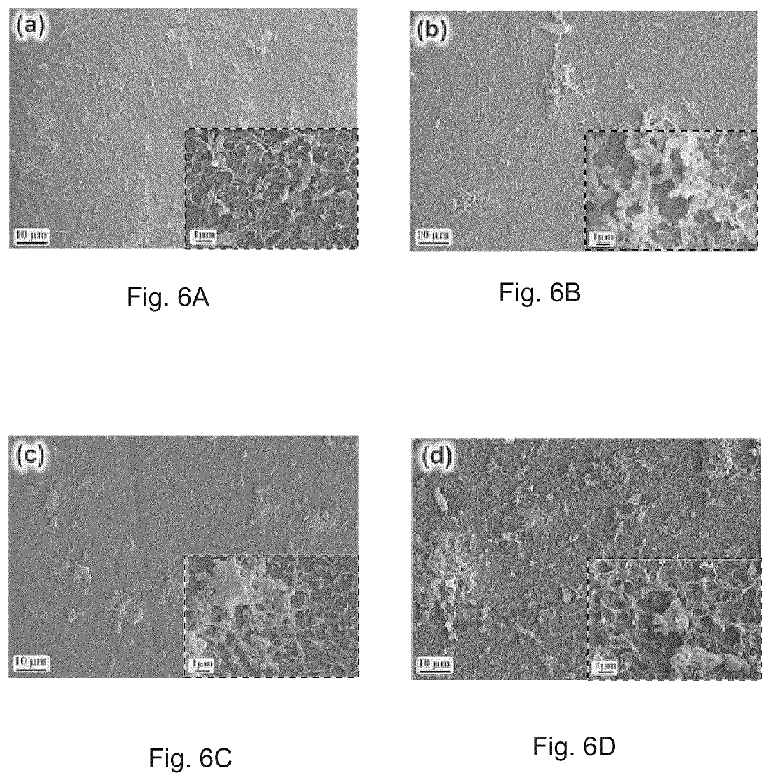

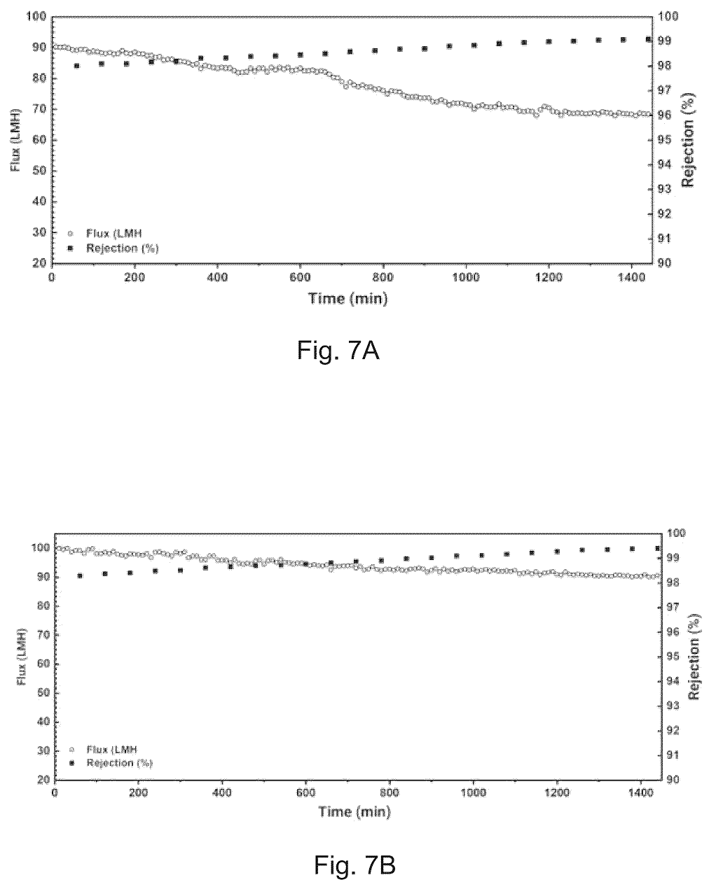

Table 5 shows the performance of various GRE-LRO membranes prepared using the procedure described above in desalination tests compared to the performance of commercial RO membranes in the same test. FIG. 6 presents the effect of Lignin incorporation into the TFC selective layer on membrane morphology and structure. The Lignin-modified TFC membrane showed about 10% reduction in water flux with increasing NaCl rejection after 24 h of continuous filtration of NaCl solution, while the unmodified TFC membrane showed about 35% reduction in water flux after 24 h of continuous filtration operation, indicating higher antifouling property for membrane modified with Lignin (See FIG. 7).

TABLE 5
Lignin-modified TFC RO membrane performance and properties
(NaCl solution 2000 ppm, ΔP = 225 psi, Feed
velocity = 4 lpm, Temperature = 26° C.)

| | Water | Water | NaCl |
|---|---|---|---|
| | flux | permeability | Rejection |
| Membrane | (LMH) | (LMH/bar) | (%) |
| GRE-RO-55 | 46.5 | 2.39 | 98.60 |
| GRE-1LRO-67 | 76.0 | 4.97 | 98.01 |
| GRE-1LRO-68 | 52.0 | 3.40 | 98.85 |
| GRE-1LRO-69 | 49.0 | 3.20 | 99.10 |
| GRE-RO-58 | 59.0 | 3.86 | 98.50 |
| GRE-2LRO-62 | 42.0 | 2.75 | 99.10 |
| GRE-2LRO-63 | 40.0 | 2.61 | 99.15 |
| GRE-2LRO-64 | 46.0 | 3.00 | 99.20 |
| GRE-LRO-113 | 97 | 6.34 | 98.75 |
| Suez-AG (Commercial) | 50.3 | 3.29 | 98.50 |
| Suez-AK (Commercial) | 126.0 | 8.23 | 95.10 |
| Dow-BW30 (Commercial) | 65.5 | 4.28 | 98.05 |

GRE-1LRO membranes were prepared using the same procedure for the support preparation and interfacial polymerization, except 0.5-5 wt % Lignin and 0.1 wt % SDS was added to the diamine solution. GRE-1LRO-67 membrane exhibits much higher water flux and slightly lower salt rejection than the GRE-RO-55 membrane without Lignin in the diamine solution, while other Lignin modified membranes show lower flux and higher salt rejection than the unmodified membranes (GRE-RO-58).

GRE-2LRO and GRE-LRO-113 membranes were prepared using the same procedure for the support preparation and interfacial polymerization, except 0.5-5 wt % Lignin and 0.15-0.2 wt % SDS were added to the diamine solution. GRE-2LRO membranes exhibit much lower water flux and higher salt rejection than the membranes with 0.1 wt % SDS and without Lignin in the diamine solution. These membranes would be perfect alternatives to prepare RO membranes for seawater desalination. Interestingly, GRE-LRO-113 shows improved performance in terms of flux (48% higher than commercial Dow-BW30 membrane) and rejection.

### Example 4: Preparation of Antibacterial Thin Film Composite Polyamide RO Membranes Incorporated with Silver-Based Metal-Organic Frameworks (Ag-MOFs) for Desalination

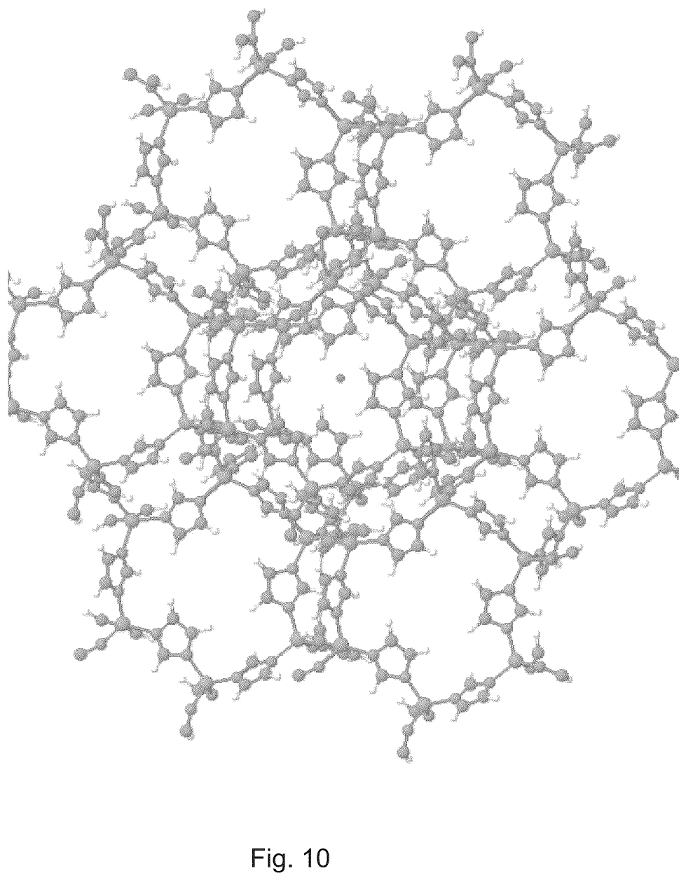

The structure of the polyamide may incorporate an anti-microbial metal organic framework, such as a silver-based metal organic frameworks. The preparation procedure of these antibacterial RO membranes is similar to Examples 2 and 3, except that the diamine aqueous solution was incorporated with 0.005-0.05 wt % of silver-based metal organic frameworks (Ag-MOFs) to modify the surface properties of TFC polyamide RO membranes and to make antibacterial TFC membranes for water treatment. The predicted structure of the Ag-based MOFs is illustrated in FIG. 10. An anti-microbial metal organic framework may reduce fouling of the membrane. The anti-microbial metal organic framework may be prepared by preparing an aqueous silver nitrate solution. A ligand solution may be prepared comprising 2-imidazole dissolved in an alcohol, at a ratio of approximately 0.3 g-0.5 g of 2-imidazole per 90 mL of alcohol. The ligand solution may be added to the silver nitrate solution. A formed precipitate may be recovered and dried, the precipitate being one

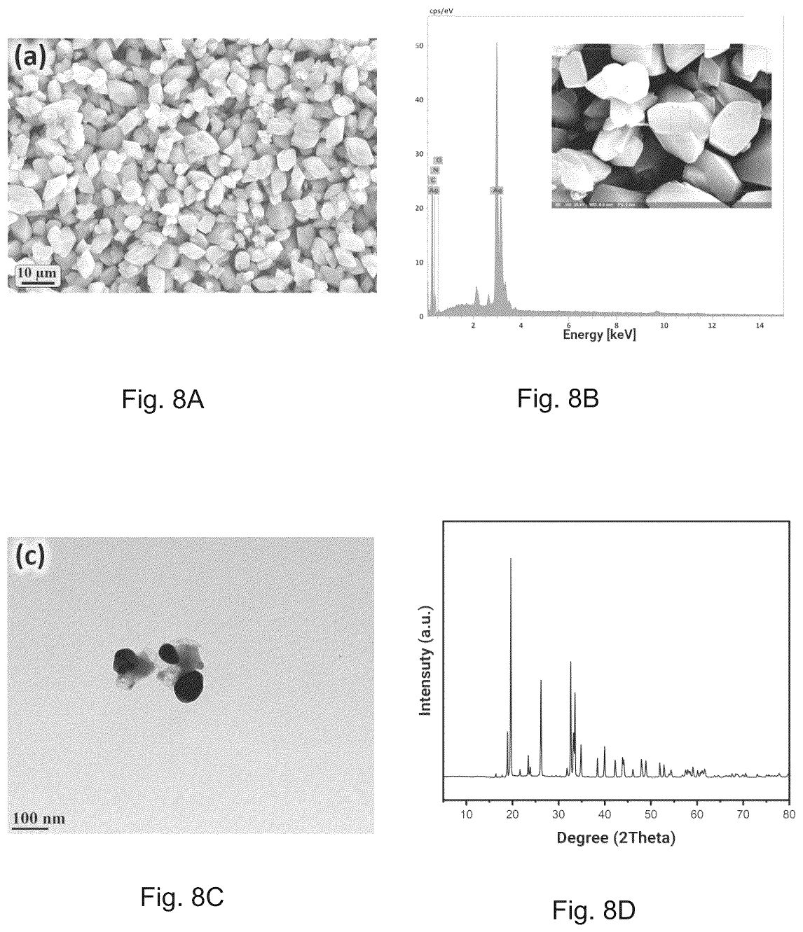

The ligand solution may comprise 2-imidazole dissolved in an alcohol, at a ratio of 0.3 g of 2-imidazole per 90 mL of alcohol. For the preparation of the Ag-MOFs, first 0.6 gr of silver nitrate solution as a metal source was dissolved in 90 mL of water by stirring for 5 min followed by 2 min sonication. The ligand solution was prepared by dissolving 0.3 g of 2-imidazole in 90 mL of ethanol by stirring for 5 min, followed by 2 min sonication. The ligand solution was then gradually added to the metal solution while stirring at room temperature. The mixture was allowed to stir for another 30 min to complete the reaction. After 30 min of reaction, the precipitate was recovered, washed with fresh ethanol, and deionized water several times, and finally dried at 60° C. for 4 hr. Here, taking advantage of the antimicrobial properties of the diazole-containing ligand and of Ag as the most well-known biocidal metal resource, we synthesized a new nano-size Ag-MOFs (See FIG. 8) that offers high antimicrobial properties for modified membranes. The production method of these Ag-MOFs is facile, environmentally friendly, and inexpensive, which is carried out at room temperature. Large quantities of these Ag-MOFs nanomaterials can easily be produced without any expensive equipment and do not require particular safety conditions.

To prepare antibacterial TFC RO membranes, the aqueous diamine solutions comprising of 1-3% w/v MPD, 0.5-5% w/v dimethyl sulfoxide, 0.5-2% v/v triethylamine, 0.5-2% w/v camphor sulfonic acid, surfactant (0.01-0.2% w/v sodium dodecyl sulfate or 0.01-0.5 Triton x-100 (C₁₄H₂₂O(C₂H₄O)ₙ) or 0.01-0.5 Tween 80 (C₆₄H₁₂₄O₂₆)), and 0.005-0.05 wt % of Ag-MOFs were poured on the surface of PSf substrate for 120 sec. After wiping off the excess diamine solution from the support surface, the organic solution containing 0.15% w/v TMC and 10% v/v co-solvent in hexane are gently poured on the surface of amine-saturated PSf support for 60 sec to initiate the interfacial polymerization reaction. After completing the reaction, the organic solution was drained off from the membrane surface, and then the membrane was put in the oven at 80° C. for 5 min without exposing it to the atmosphere to make the polyamide layer robust and tough. The heat-cured composite membranes were washed with water to remove the unreacted reagents. The post-treatment of pristine TFC membrane is then carried out with glycerin (in the range of 5-20 w/v %) and/or polyvinyl alcohol (PVA, 0.5-2 w/v %).

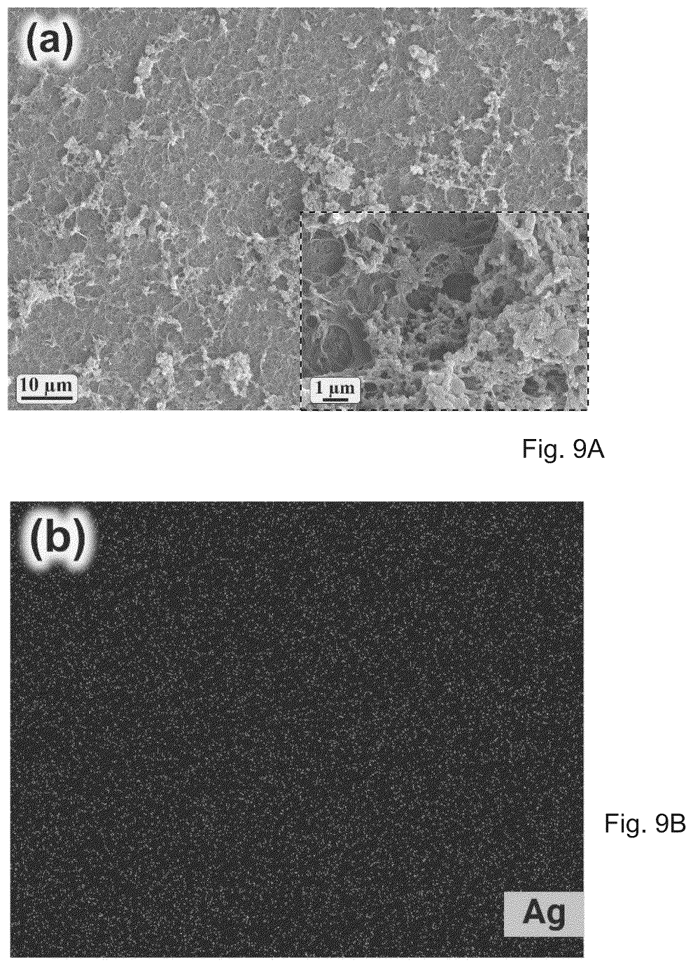

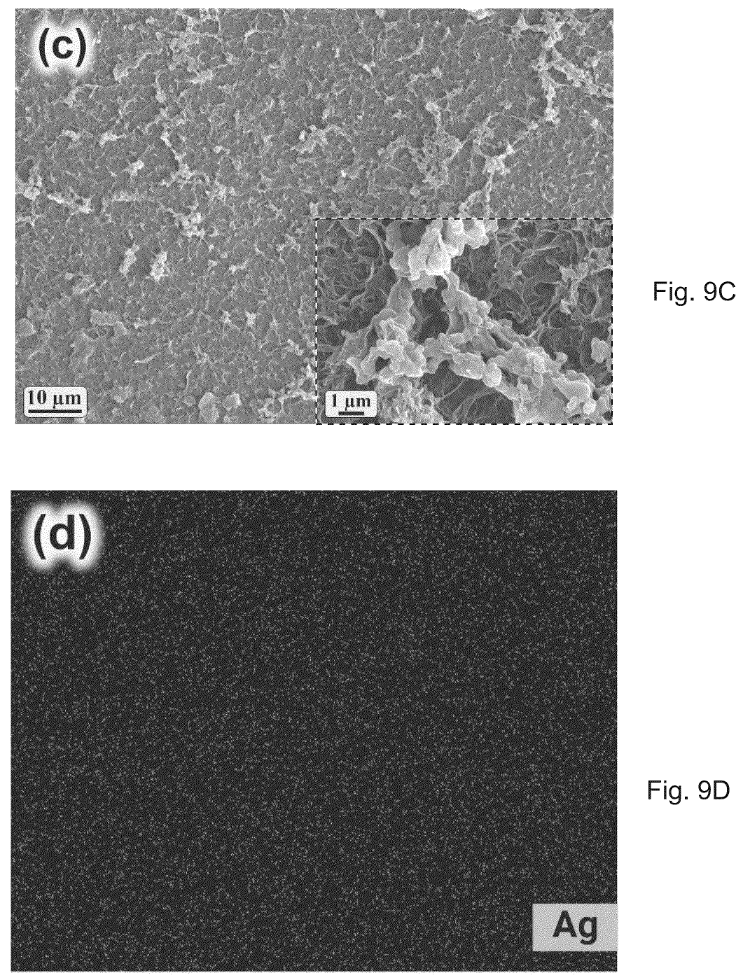

Table 6 shows the performance of various GRE-ARO antibacterial membranes prepared using the procedure described above in desalination tests compared to the performance of commercial RO membranes in the same test. An anti-microbial metal organic framework may reduce fouling of the membrane. Incorporating Ag-MOFs into the TFC polyamide layer to make the thin film nanocomposite selective layer improved the flux without scarifying the salt rejection. FIG. 9 shows the SEM images and EDX of antibacterial membranes before and after filtration tests. Even after filtration, the sharp silver peak for the membranes indicates that their Ag-MOFs nanoparticles are not washed out and are present at the surface of TFC RO membranes.

TABLE 6
Ag-MOFs modified TFC RO membrane performance and properties.
(NaCl solution 2000 ppm, ΔP = 225 psi, Feed
velocity = 4 lpm, Temperature = 26° C.)

| | Water | Water | NaCl |
|---|---|---|---|
| | flux | permeability | Rejection |
| Membrane | (LMH) | (LMH/bar) | (%) |
| GRE-RO-49 | 58.5 | 3.82 | 98.55 |
| GRE-ARO-185 | 97.0 | 6.34 | 98.1 |
| GRE-ARO-186 | 105.0 | 6.86 | 98.15 |
| GRE-ARO-187 | 70.0 | 4.58 | 94.73 |

In the claims, the word “comprising” is used in its inclusive sense and does not exclude other elements being present. The indefinite articles “a” and “an” before a claim feature do not exclude more than one of the features being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method of making a high-performance thin-film composite membrane, the method comprising:
(i) preparing a polysulfone (PSf) support membrane by:
(a) dissolving PSf in dimethylformamide (DMF) so as to form a uniform solution;
(b) maintaining a concentration of polyvinylpyrrolidone in the uniform solution at a range of 0.5-3.0 wt % by adding one or more solvents;
(c) degassing the solution, and thereafter casting the solution on a 90-110-micron thick nonwoven polyester support while maintaining a cast thickness at about 0.12 microns to form a cast film;
(d) immediately immersing the cast film in a water precipitation bath and initiating phase separation;
(e) removing the one or more solvents, and thereafter treating the formed support membrane with ethanol followed by hexane;
(ii) contacting the formed support membrane with an aqueous diamine solution comprising 1-3% w/v MPD, 0.5-5% w/v dimethyl sulfoxide, 0.5-2% v/v triethylamine, 0.5-2% w/v camphor sulfonic acid, and 0.01-0.2% w/v surfactant (0.01-0.2% w/v sodium dodecyl sulfate, 0.01-0.5 Triton x-100 (C₁₄H₂₂O(C₂H₄O)ₙ), or 0.01-0.5 Tween 80 (C₆₄H₁₂₄O₂₆)), for a time period of about 120 seconds;
(iii) removing excess aqueous diamine solution from the support surface;
(iv) gently pouring an organic solution containing 0.15% w/v TMC and 5-15% v/v co-solvent in hexane on the support surface and initiating an interfacial polymerization reaction;
(v) draining the organic solution from the support surface, and heating the support surface and membrane formed thereon at about 80° C. for about 5 minutes; and
(vi) washing the formed membrane.

2. The method of claim 1 in which the co-solvent comprises one or more of chloroform and DMF.

3. The method of claim 1 in which step (i)(a) comprises dissolving 14-16% polysolfone in dimethylformamide so as to form the uniform solution.

4. The method of claim 1 in which step (b) further comprises adding one or more solvents of one or more of N-methyl-2-pyrrolidone, Dimethylsulfoxide, DMF, and Dimethylacetamide.

5. The method of claim 1 in which the aqueous diamine solution from step (ii) comprises a co-solvent of one or more ethanol and acetone.

6. The method of claim 1 in which step (iii) further is carried out after 30-180 seconds.

7. The method of claim 1 in which step (iv) further comprises 10% v/v co-solvent of one or more of chloroform and DMF in hexane on the support surface and initiating the interfacial polymerization reaction thereon to form a polyamide selective layer on the support surface.

8. The method of claim 1 in which step (v) is carried out after 30-90 seconds.

9. The method of claim 1 in which contacting, in step (ii) comprises spraying or pouring.

10. The method of claim 1 having an anti-microbial metal organic framework to reduce fouling of the membrane, and further comprising:
(1) preparing an aqueous silver nitrate solution;
(2) preparing a ligand solution comprising 2-imidazole dissolved in an alcohol, at a ratio of approximately 0.3 g-0.5 g of 2-imidazole per 90 mL of ethanol;
(3) adding the ligand solution to the silver nitrate solution; and
(4) recovering and drying a formed precipitate that comprises an anti-microbial metal organic framework;
in which, before step (ii) is carried out, adding 0.005-0.05 wt %. the anti-microbial metal organic framework to the aqueous diamine solution.

11. The method of claim 1 in which, before contacting in step (ii), mixing the aqueous diamine solution with a lignin solution containing 0.5-5 wt % of a hydrophilic and green lignin.

12. The method of claim 1 in which, in step (1)(c), casting the solution on the nonwoven polyester support is conducted using a semi-continuous casting machine.

13. A high performance thin-film composite membrane comprising a multilayer permeable structure that comprises:
a polysulfone (PSf) support membrane layer with a total thickness of about 150 microns; and a selective layer that comprises a polyamide made of diamine and trimesoyl chloride, and that has a thickness of less than or equal to 200 nm, in which the polyamide has a structure that incorporates surfactants.

14. The high performance thin-film composite membrane of claim 13 in which the surfactants comprise one or more of sodium dodecyl sulfate, Triton x-100 (C₁₄H₂₂O(C₂H₄O)ₙ), or Tween 80 (C₆₄H₁₂₄O₂₆).

15. The high performance thin-film composite membrane of claim 13 having a high-salt-selectivity (>98% of NaCl).

16. The high performance thin-film composite membrane of claim 13 in which the structure of the polyamide incorporates a silver based anti-microbial metal organic framework.

17. The high performance thin-film composite membrane of claim 16 structured to have an anti-microbial effect of 5 colony forming units (CFU) or less determined by a membrane filter test.

18. The high performance thin-film composite membrane of claim 13 in which the structure of the polyamide incorporates a hydrophilic lignin.

19. The high performance thin-film composite membrane of claim 18 structured to reduce fouling of the membrane with a flux decline of equal to or less than 10% over 1400 minutes in a long term performance test.

20. The high performance thin-film composite membrane of claim 13 structured for brackish water reverse osmosis with a water permeability of 2.39 LMH/bar or higher (up to 6.86 LMH/bar).

21. The high performance thin-film composite membrane of claim 13 structured for sea water reverse osmosis with a water permeability of 0.68 LMH/bar or higher.
